(19) United States
(12) Patent Application Publication
(10) Pub. No.: US 2003/0004958 A1
(43) Pub. Date: Jan. 2, 2003

(54) Platonic reasoning process

(76) Inventor: Lucian Russell, Alexandria, VA (US)

Correspondence Address: Greenberg and Lieberman Law Offices, 314 Philadelphia Ave., Takoma Park, MD, 20912, US

(21) Appl. No.: 09/896,601

(22) Filed: Jun. 29, 2001

(51) Int. Cl. G06F 7/00; G06F 17/00

(52) U.S. Cl. 707/100

(57) ABSTRACT

The distinguishing feature of the present invention is that it provides a means to answer a query about a database when the data in the database is not complete or is not considered to be trustworthy. The adverb Platonic is used to describe the reasoning process because of Plato's metaphorical description of how human beings perceive reality. The metaphor was one of a fire in a cave. Plato said that human beings cannot perceive objects in the real world in their exact form. If an object were in a cave, a fire in the cave would cast a shadow of that object on the wall. That shadow, however, would alter shape and the edges would appear to flicker. A person in that cave facing the wall would not be able to see the true form of the object, only the shadows. However, by looking at those shadows it would be possible to get a good approximation of the shape of the actual object. That is the intent of the present invention, to process the data as so as to obtain a good approximation of the object in the real world that the data represents.

Priority is hereby claimed to U.S. provisional patent application No. ______ filed on ______.

### BACKGROUND OF THE INVENTION

There has been extensive work in reasoning about the data in databases going back over 40 years. This work encompasses monotonic reasoning, best known in the guise of automatic theorem proving, and non-monotonic reasoning of truth maintenance.

There has been extensive work in the area of applying Bayesian probability measures to complex situations, notably the work of Judea Pearl (Probabilistic Reasoning in Intelligent Systems : Networks of Plausible Inference), who maintains a bibliography of over 1000 references. Results are documented in many conferences on uncertainty reasoning. The only known practical example of the application of this formalism has been in text retrieval. The INQUERY system, developed at the University of Massachusetts at Amherst uses the relative occurrence of words in documents as an estimate of probability and then performs a Bayesian net inference on the data.

There has been extensive literature in fuzzy sets. For a baseline see Klir's “Fuzzy Sets and Fuzzy Logic: Theory and Applications”, and “Uncertainty-Based Information : Elements of Generalized Information Theory.” Again, the question arises on how to assign fuzzy measures. For a small number of measures of simple systems they can be assigned by a human being. This breaks down when the problem becomes too complex.

Baconian measures have not been applied mathematically and systematically except in a few academic settings. They have not been used as a technique to compute fuzzy measures.

The use of filters was discussed in great detail by Lucian Russell in “Posits and Rationales”, a Ph.D. dissertation at George Mason University. It has been submitted as documentation for patents in 1998.

Computer representations of information are stored in a database. The following definitions are those generally used by Information Technology standards bodies. A database consists of data elements and their relationships and the range of values that the data representation is expected to assume. The data that describes other data is called metadata. The metadata structure of data in terms of groupings of data and linking of groupings is the schema. The metadata structure that describes the expected range of values is called the integrity constraints. A database that is organized into a set of tables, where linkages among tabular entries are represented by explicit data values present in those tables, can be called a relational database. This is because the tables are a representation of the mathematical construct called a relation. The term relation is mathematically defined whereas the term relationship has a more general meaning, and requires a context in which it is precisely defined.

A relational database has the property that any of its data elements can be reassembled into another table using a combination of three operations, select, project and join. A complex operation consisting of the use of these operations, perhaps multiple times, is a query. The use of a sequence of queries can also be used to create new tables. This process has been mathematically demonstrated to be identical, under three assumptions, to be the same as proving an equivalent mathematical theorem using that data. Because of this fact a process that queries data is a reasoning process. Therefore the Platonic Reasoning Process is also a Platonic Querying Process.

### SUMMARY OF THE INVENTION

The distinguishing feature of the PRP is that it provides a means to answer a query about a database when the data in the database is not complete or is not considered to be trustworthy. The adverb Platonic is used to describe the reasoning process because of Plato's metaphorical description of how human beings perceive reality. The metaphor was one of a fire in a cave. Plato said that human beings cannot perceive objects in the real world in their exact form. If an object were in a cave, a fire in the cave would cast a shadow of that object on the wall. That shadow, however, would alter shape and the edges would appear to flicker. A person in that cave facing the wall would not be able to see the true form of the object, only the shadows. However, by looking at those shadows it would be possible to get a good approximation of the shape of the actual object. That is the intent of the PRP, to process the data as so as to obtain a good approximation of the object in the real world that the data represents.

The most general type of schema structure is called an Ontology. It provides a structure, frames containing slots, with inter-frame linkages, that is so general that it suffices to represent all the different varieties of metadata that have been found to be useful, and it can be extended to encompass new types of metadata. The Ontology provides the description of the data about the real world that, if available, represents the object of set or objects (1) about which data is collected and (2) queries made. In other words the Ontology can represent the database that describes the ideal description, the one that we would wish to obtain. The Ontology, because of its generality, can also describe the limitations that existed and constrain the completeness and accuracy and validity of the data that was actually collected in the real world.

Therefore the Ontology is the means whereby we (1) organize the computer representations of information together with the representation of the presumed relationships that exist among elements of that information, and (2) applies and records corresponding measures of completeness and correctness of that information.

The third step in the process is to generate new measures. The process is valuable because it is a means to generate “fuzzy” measures. The discipline of “Fuzzy Sets” and “Fuzzy Logic” has been well established for over 35 years; it is the mathematics that results from generalizing the binary function describing the membership relation of subsets of a set to a more general function. A binary relation is a mapping of an element “a” of a set “A” and a subset “S” of “A” to one of two numbers, “1” or “0” depending on whether “a” is said to be a member of the subset “S”. This mapping is called the membership function. When the mapping is not just to “1” or “0” but to numbers in between then the membership function is “fuzzy”.

Fuzzy measures and the resulting fuzzy logic has been well accepted in the United States because of a linguistic prejudice against the word “fuzzy”. The mathematics, however, exists independent of linguistic conventions, and has been applied successfully to many industrial processes in Japan, where patents have been granted. In general the strength of the methods based on “fuzzy logic” is that they are used to create a simpler mathematical model of the control processes that need to be managed, which enable the creation of more efficient techniques for controlling the automatic operation of machinery.

Although the usefulness and applicability of fuzzy mathematics is well demonstrated for nearly two decades, the extension of these methods to more general, non mechanistic problems has been halted by the difficult in setting forth general criteria by which to assign the measures to real world data. A similar problem exists in using probabilistic techniques that are called “Bayesian”. These require the generation of a large number of initial probability values that must be assigned to data, and the task of generating these probabilities has proved to be too complex for the technique to be useful to real problems, with the exception of the Computer Science discipline of Information Retrieval.

The PRP, however, provides a mechanism for generating fuzzy measures. These are the “new measures” that provides a measure of a new category of information that summarizes the information available concisely. The latter summarization is what is done when fuzzy measures are applied in mechanical control systems. The process allows for two techniques to be applied, linguistic variable mapping and precision through abstraction.

1. Linguistic variables are words assigned to ranges of data values. An example is the risk of an investment in a company's stock where the chance that you would make a 100% profit on your investment would be characterized by one of the words “certainly, probably, plausibly, possibly, conceivably and inconceivably”.

2. Abstraction occurs when detail is omitted. If values for three variables are needed to describe an object, but only two are certain, one may define a new object that is described by just the two variables. For example to designate an area as a “mountain” one needs the height of the object, whereas a “mountain range” is a flat area on the map that has both mountains a non-mountainous areas. Lacking the height coordinate the latter more abstract term is appropriate.

Using a-priori principles is one way of assigning the value of fuzzy measures. The PRP however, uses a more novel technique whereby the measures are induced by the data. There are several meanings for the word induction, but the one that is intended here is the one from electromagnetic theory. In this theory an electric charge moving through a conductor induces a magnetic field, and if another conductor is placed in the same field a current in the opposite direction. The data that is actually loaded into the database creates a series of objects which generate an description of those objects with respect to the description loaded in the Ontology.

The foundation of this technique is the application of implicit functions. In mathematics a function is a table of values, like a relation, with some restrictions. Usually people describe functions “intensionally”, by a formula, especially if the formula has an infinite number of values like x*x=y. An alternative is to describe functions “extensionally”, as a table where all values are explicitly recorded. Any given relational database can be described as a set of extensionally defined functions. These can in turn generate self-describing measures, of which one familiar example is quartiles (quartiles are four groupings of numerical values within a set of numbers from the lowest to the highest). By applying measures created by self-describing functions to the database it is possible to create fuzzy measures. These measures are then applied to the data in the database. The data and their fuzzy measurements enable the us of reasoning, the application of rules of the form “If X then Y” where the logical expressions X and Y contain terms that include the fuzzy measures.

### DETAILED DESCRIPTION

The PRP is realized by adding a set of processes, realized in software, into a system that performs reasoning on data. The PRP is the process of reasoning about the set-up of the data that will be used by process that reasons on exact data. Some basic processing functions are common to both types of reasoning, and so the software will share some programs in common. The baseline system components perform reasoning on exact data. As explained above, reasoning about a hypothesis using data in a database is the same thing as running a set of programs that perform a query on the database. That is because a hypothesis that can be validated or disproved on a data base has the form “there exist data elements in the database form Y that match the description X” can be proven by the query “select all data from D that match the description X”. If no such data exists the query returns no data and thereby disproves the hypothesis.

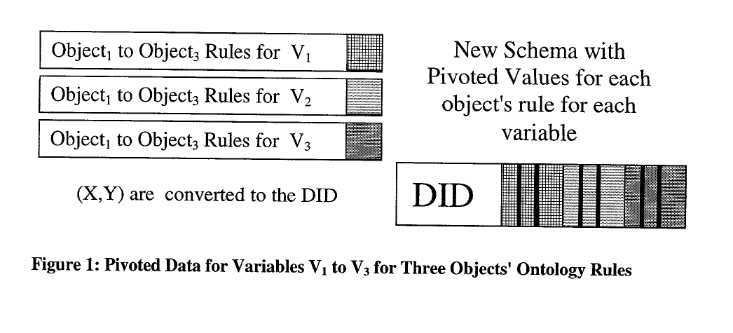

The system will be shown in terms of a software Architecture diagram, one which identifies software components with special functions that interface with one another. The Architecture of the system is shown in FIG. 1. It is a 3-tier architecture; the terms layer and tier will be used interchangeably. The first tier contains a user interface, a software client, that sends data to and receives it from software on the second tire, the middleware layer. At the bottom of the Figure, Tier 3, are Database Management Systems (DBMSs) accessing databases containing the original information that the system must access.

The baseline reasoning process without any PRP functions is simple. In the Client Tier there is a box that says “Reasoning Chains and Filter Editor” and one that says “Display Results”. The Reasoning Chain is the statement of the hypothesis to be proved, which may also be seen as a set of queries. There are no filters in this case. The results of the queries are displayed where indicated, if there is data to be displayed, and a “no data found” message is displayed otherwise. The software interacts along the path shown as the narrow, black think lines with triangular solid arrowheads. Note that the PRP Plug-In is bypassed and the SQL 3 Engine is directly accessed. The Object-Relational Database Management System is a standard middleware software Commercial Off the Shelf (COTS) software component, used to overcome formatting differences among the different data sources.

The description in FIG. 1 covers the case where the PRP is used.

Tier 1

1. The Ontology Editor is the interface to the Ontology Builder (an example is available at the Knowledge Sharing Laboratory, www-ksl.stanford.edu at Stanford University). An Ontology is a general representation format for systems that represent knowledge about data items and their inter-relationships, including the various elements of metadata that describe the data. When an instance of an Ontology is built it will contain descriptions of (1) the ideal collection of descriptive data, (2) the data that is actually available, (3) transformations that are admissible between the two formats, (4) functions used to filter data that will be transformed, and screens that support the generation of new measures and objects that are the result of the PRP. This interface supports the first part of the PRP: it organizes computer representations of information together with the representation of the presumed relationships that exist among elements of that information.

2. The Results Display Engine is an interface to COTS products on the client platform that are used to view the results of performing reasoning using the PRP.

3. The User Interface for Reasoning Chains: This user interface is to two things, build the hypothesis and its associated reasoning chain (or query sets) and assign uncertainty management conditions. This supports the first half of the second part of the PRP: it records the measures of correctness corresponding of the information that will be used. It also feeds rules to any reasoning engine that may be needed to enhance the functionality of the Object Relational Database.

4. The Screens Editor is the interface to the Ontology builder that is used to support the second half of the second part of the PRP: record the measures of completeness corresponding to the information that will be used.

In addition there are system administrators who need interface with the system through COTS product interfaces. These are:

5. The Command Center: The Object Relational Database's Interface

6. Math Function Editor: This is an environment for building programs that are compiled and inserted into an executable program library for use in the Object Relational database by the PRP.

Tier 2, the Middleware

Middleware is used to assemble data from multiple data sources, shown as databases in Tier 3. The following components constitute the middleware:

1. Object Relational Database: the Object-Relational database management system (ORDBMS) that is a general-purpose data management system that contains the ability to store relational data and other types of data. Although many of its functions could be managed purely be a relational database doing so would make for more complex application programs that access and use that data. In the diagram it will build databases of filters and screens because any person using the PRP will run a problem, decide on some changes and want to store the prior working assumptions in a database for reuse.

2. The Reasoning Engine: the Reasoning Engine executes rules that impact both the Ontology and the data in the results database. It is likely to be part of the ORDBMS, but is shown separately just in case a more powerful reasoning system is required.

3. PRP Application Server: the activities of the client user interfaces is coordinated by this application. It will interface with the ORDBMS to load screen and filters, and initiate the access to raw data and initiate the use of rule sets in order to generate results. This is the third part of the PRP: it generates a new, novel and useful measure that provides a useful new description of the information available that summarizes it concisely.

Tier 3

This is the data that is input to the system.

Refining Hypotheses is the term used describe the user's activity of interacting with the data as follows:

1. The user come to the database with an initial hypothesis which he/she wants to validate using the data in the database.

2. The user examines the data and comes up with a chain of reasoning, a set of steps during which the data in the database will be accessed, transformed, intermediate results created and finally a result generated.

3. The results are examined and the process is repeated with either a reformulated hypothesis, a change in the scope and/or transformations of the data that is to be examined or both. The new results are examined.

4. The process is repeated until the user is satisfied.

This interaction can be done with or without using the PRP. The PRP provides a more powerful way for the user to use the data available

We assume that the user is familiar with the specialized field of inquiry to which the data in the database is relevant. That means specifically that due to the user's personal training and experience he/she knows what types of hypotheses may be propounded and validated with the data. For purposes of illustration we assume that the user is processing data to assess data describing the current situation in which it is suspected their may be a threat to resources, e.g. business, medical, or military assets. The data in the database may admit to multiple interpretations. Each can be formulated as an initial decision hypothesis: as follows: : “the current situation X poses a threat to my resources Y at Z”. After the data is analyzed one of the following may be inferred:

1. Contradiction: “the current situation X does not pose a threat to my resources Y at Z”

2. Alternatives: “the current situation X poses a threat to my resources Y at W” OR “the current situation X poses a threat to my resources Y′ at Z”

3. Ambiguity: “the current situation cannot be assessed with sufficient certainty to support any hypothesis”.

To use the data in the computer the hypothesis must be formulated in a specific manner. Because R. Reiter proved in 1984 that a query to a relational database was mathematically equivalent to a proof that the data supported a hypothesis the form of the hypothesis can be that of a query. The conversion from the verbal human statement to the computer format of the hypothesis is a two step process (the notation—backwards E means “there exists” and inverted A means “for all”):

1. Expand the Meanings:

(∃(a,b,c . . . ) with relationships r₁, r₂, . . . )whenever situation X exists.

(∀(a,b,c . . . ) with relationships S₁,s₂, . . . ) define the my resources Y.

The area Z is defined by criteria (A,B,C, . . . )

2. Restate the verbal hypothesis as a query: “the evidence available in the database shows X, Y exist and Y meets criteria (A,B,C,. . . )”.

The word used in step 2, however, was not “data” but “evidence”. Once the conversion is made, the evidence will either (1) support the assumptions of a decision hypothesis H₁ or (2) contradict it by supporting its contradiction H₁^{C}, or (3) not be relevant at all. Data is not necessarily evidence, and a method of relevance determination is provided to convert the stream of data to evidence. One of its actions is to defined exactly when redundant data is present. Such data need not be considered (eliminating redundant data solves the info-glut problem). This is one of the explicit PRP process steps, converting data to evidence by building screens. The useful advantage of this step potentially reduces the massive volume of data (also known as “infoglut”) and makes both the reasoning process and results more amenable to being effectively reviewed by a human.

Returning to the point about alternative hypotheses: whenever evidence is not relevant to one hypothesis about a situation it might be relevant to another. Thus this step of looking at alternative hypotheses can be applied to situations where multiple explanations for data are possible. A user may start out with one hypothesis, and monitor the situation, looking for new evidence that suggests that an initial hypothesis is now negated. This means that when the OPRP is used for monitoring it provides a useful advantage as all the plausible hypotheses by be compared against the evidence compared.

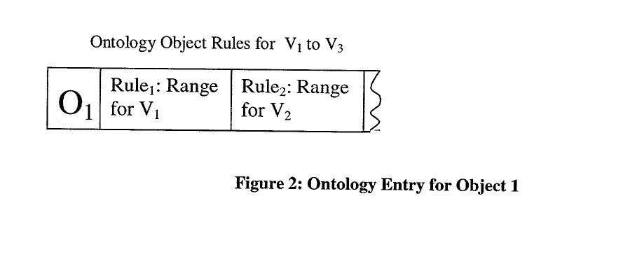

In FIG. 2 we see that Hypothesis₁ predicts two negative events and three positive ones, but has 4 events unaccounted for. The others have different coverage. Under the circumstances Hypothesis₂ is the best. The goal of the step in the PRP is to enable such a comparison.

The process steps are:

1. Initialize problem space: specify

Decision: a hypothesis OR a set of hypotheses.

Data sources, objects, algorithms etc.

2. Generate missing data

3. Establish the Chain of Reasoning: data transformations needed to gather the data neededd to test the hypothesis or hypotheses.

4. Set thresholds of uncertainty for valid data.

5. Create screens to convert data to evidential objects.

6. Run hypotheses verification & compare results.

7. Adjust the abstraction level to encompass evidence.

8. Potentially Perform Data Mining to improve results.

The first step is to state the subjective decision hypothesis or a set of competing hypotheses as a query. This means reformulating each hypotheses as a logical combination of one or more statements of the form:

“There exist objects whose properties {Pᵢ} have value ranges {Rᵢ}”

“All objects of type X have properties {Pᵢ} within value ranges {Rᵢ}.”

In logic these are the generalizations of statements containing “OR” conditions and “AND” conditions.

The second step is to use the Ontology editor to describe the

1. Data Sources: form and constraints for all levels of available data inputs, and the

2. Objects: complete description of all properties of objects that are detectable, of sensors, and abstract concepts (Ontology). This includes screen objects described below Further one should specify any additional

3. algorithms, i.e. any new techniques embodied in programs that must be added to the PRP to enable filtering of data or eliminating uncertainty. This includes filter algorithms and thresholds described below.

These may be submitted also as input to the object relational database management system as needed.

Missing Data is generated after a subjective judgement by the PRP user. It may occur as an initial step, or during re-iteration of previous steps. Some sources

Projection of prior data about objects no longer visible,

Assumptions based on knowledge of enemy doctrine, or

Simulated data based on the data at hand.

Multiple hypotheses may reflect multiple guesses at the missing data and its values. This data will be necessary for making projections when not all of the area with possible data is observed.

Every data manipulation is the formal equivalent of reasoning step, so the total is called the Chain of Reasoning. The Chain of Reasoning is therefore the set of transformations from the raw data to the data used in the query based solely upon the meaning and form of the data. This is the set of steps that one uses to go from the data to the hypothesis. It is the data upon which the query representing that hypothesis is run. The Ontology will contain precise descriptions of all the data formats needed, and as needed these will be loaded into the ORDBMS.

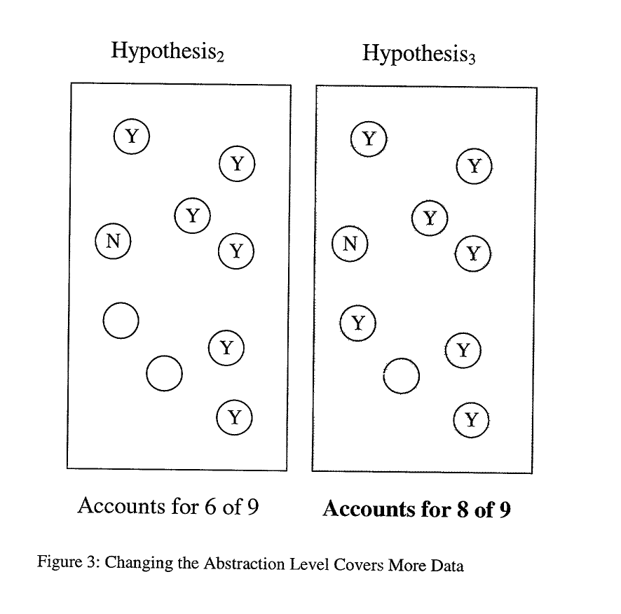

FIG. 3 is a visualization of four sources of data that will be used to generate the Final View, data used to test the hypothesis. Source 1 is input to other data streams and is therefore some standard immutable description like a terrain map. Other processing steps combine or fuse data from the different sources to make intermediate data sets. The “F” symbol stand for filtering action described below.

The chain of reasoning must be constructed with the knowledge that not all of the data is equally valid. Whenever tests can be devised to eliminate data that is too questionable for use they will be incorporated as a filter. The filter admits some data and excludes other data. To use one, however, a threshold value must be set. That is the user's tolerance for data uncertainty. In the PRP this sub-process is explicit and may be reset to a different value if the hypotheses need to be looked at a later time with a different tolerance for uncertainty. Specifically, although traditional Pascalian Probability measures can be used, as well as Baconian Probability Measures, explained below, fuzzy measures can be used as well, these can take the form of explicit assignments of values, or the values may be inferred from the Pascalian and Baconian measures, a KEY feature of the PRP.

Baconian Probability is not as well known as Pascalian Probability, although de-facto it is the basis of scientific induction and is used extensively albeit informally. Let B(H) be the monadic (i.e. True of False) Baconian Probability of a hypothesis H and B(H,E) the dyadic conditional probability of H given E; then these are the formal mathematical properties [Schum, The Evidential Foundations of Probabilistic Reasoning, pp254-255]:

(1) Ordinal Property:

monadic case: B(H₁)≧B(H₂) or B(H₂)≧B(H₁)

dyadic case: B(H₁,E₁*)≧B(H₂, E₂*) or B(H₂, E₂*)≧B(H₁,E₁*)

(2) Negation Property:

monadic case IF B(H)>0 then B(˜H)=0

dyadic case: IF B(H,E*)>0 then if B(˜E*)=0, then B(˜H,E*)=0

(3) Conjunction Rule:

monadic case: IF B(H₁)≧B(H₂) THEN B(H₁◯H₂)=B(H₂)

dyadic case: IF B(H₁,E*)≧B(H₂,E*) THEN B(H₁◯H₂,E*)=B(H₂,E*)

(4) Disjunction Rule:

monadic case: IF B(H₁)≧B(H₂) THEN B(H₁◯H₂)=B(H₁)

dyadic case: IF B(H₁,E*)≧B(H₂,E*) THEN B(H₁◯H₂,E*)=B(H₁,E*)

(5) Contraposition:

dyadic case: B(H,E*)=B(˜E*,˜H)

The system has been of great interest to the many people who have become aware of it, but heretofore no practitioners have seen a way to interpret it to be applicable to real-world situations. The PRP provides this assignment by a novel mechanism.

The Baconian probability associated with an object is determined by (1) the object observed, (2) the question asked of it and (3) the number of tests of values of relevant variables. The innovation is to applying the probability to all terms or slots of the Ontological description of the object, not just the static attributes. For example, a jeep may have 25 possible data values or properties that describe it, but only six of them are needed for identification. Let the hypothesis H be that object X is a jeep. Suppose the data contains 4 relations each of which of six variables, and together they encompass 12 terms of the 25, but also together they account for only 5 of the 6 identifying attributes. Then the Baconian probability of the (H)=5. This corresponds to the data passing five out of six possible Baconian existence tests on the different identifying property.

This process is totally new and is a major invention within the PRP. The problem is relevance of data and the value of having multiple instances of the “same” data. This must be addressed because future technology will enable better, more accurate, and more numerous data to be collected. The challenge is how then to use them without being overwhelmed? The step is the conversion of data to evidence.

The key step is to provide a precise description of the distinctions made in the discipline of Evidential Reasoning. Let H₁ be the decision hypothesis, and D₁ a datum that supports it. If D₁ supports a decision hypothesis H₁ does the next datum D₂ support the hypothesis more, less, the same? Is it relevant at all? In Evidential Reasoning the following definitions are provided:

Directly Relevant Data: data that is used to infer the decision hypothesis H.

Corroborating Data: data that strengthens the decision hypothesis H.

Redundant Data: data that duplicates what is already known about H.

Contradictory Data: data that supports the negation of H.

Conflicting Data: data either confirms or negates Hᵢ but does so for Hⱼ.

Using the PRP technology the user:

1. enables the system to use relevant data as direct evidence,

2. fuses corroborating data,

3. screens out redundant data relevant to the competing hypotheses Hⱼ and their contradictions˜Hⱼ or Hⱼ^{C}, and

4. assigns conflicting data to the same process steps for competing hypotheses.

This is made possible by the use of the Ontology.

Hypothesis comparison requires defining the above terms precisely, and relating them to multiple hypothesis comparison. First the PRP user creates an Ontology for all objects {X₁, . . . X_{M}}, i.e. a complete logical description of the terms (a.k.a “slots) for each object i.e. properties (attributes), functions, relations and axioms. Let object X have terms (t₁, t₂, t₃, . . . ) that may be any of the types of slots mentioned. A given object may be identifiable, however, by a subset of those terms, and there may be more than one such subset. For object Xᵢ let the subsets of identifying terms be ITᵢ₁, ITᵢ₂, ITᵢ₃, . . . IT_{iM} and let ITᵢ be the set of these subsets. Note that if XTᵢ is the set of all Xᵢ's terms, and 2^{XTi} is its power set ,the set of all subsets, then the set of sets of identifying terms ITᵢ⊂2^{XTi}.

Then consider a set {d₀, . . . dₙ} of data items that establish that an instance of object Xᵢ has been observed. The first one d₀ establishes that Xᵢ exists. This means that values for the instance of Xᵢ may be filled in for it's property values, function and relation values, and the designation that certain axioms have been shown to apply. Then the rest of the elements of the set d₁. . . dₙ that also establish it are split into two subsets, the corroborating evidence {c₁, . . . cₙ₁} and redundant evidence {r₁, . . . rₙ₂}. The distinction is that dj is redundant unless it provides a value for a term that d₀ did not. Corroborating data is data that adds information about the object Xᵢ. Although it does not change the evidence that Xᵢ exists the new term values may be useful to subsequent queries that access the database. Otherwise, as they add no information, they are redundant. Formally:

Let d₁ and d₂ be relational data that consists of attributes (t₁₁, t₁₂, . . . t₁ₙ) and (t₂₁, t₂₂, . . . t₂ₘ) respectively.

Let d₁ directly identify object Xᵢ: it provides values for the subset of terms ITᵢ₁, that is an element of ITᵢ. Then d₂ is:

Redundant if it confirms the values of ITᵢ₁,

Corroborative is it confirms values using ITᵢ₂≠ITᵢ₁,

Contradictory if it does not have all the values of one of the ITᵢ elements, and

Conflicting if it identifies elements ITⱼ₁ of another object Xⱼ at the same time and place as Xᵢ.

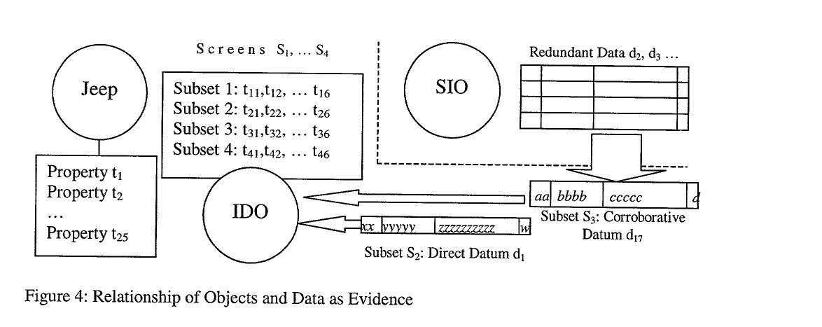

The above technique of identifying ITᵢ is called creating and using a screen. One advantage is that it reduces the data glut to a manageable flow of information. It also separates out what data accrues to what decision hypothesis about the existence of an object. Sensor fusion is now also easy to define. Every sensor is modeled as an object as well with its own Ontology. There is a line of reasoning from the output of that sensor to terms in the Ontologies of the objects that it identifies. In IT₁ the infrared detector will see that the hood of a jeep is bright, meaning the jeep is operational. The logic of this association is stored in the Ontology. The fusion is done at the ontological level. The screen is now illustrated in detail in FIG. 4.

Continuing the example, a jeep may have an ontology entry yielding a set S of 25 properties, of which any of 4 subsets S₁, S₂, S₃ or S₄ of 6 properties might identify it (the ITᵢⱼ's). These are sensor-identification objects (SIO) (new!). Then if filtered data item d₁ identifies X₁ according to S₂ we have an identification object (IDO) (new!). The value d, becomes direct evidence of the existence of X₁, and S₂ together with any additional sensed properties becomes the identification object (new process!). Then when data item dᵢ is detected it is redundant if it uses S₂ and corroborative otherwise, say using S₃, as is datum d₁₇ in FIG. 8. Adding this information updates the IDO. The IDO is the screen (new concept) with the properties in S₂ ◯S₄ together with all other properties of d₁ and d₁₇. The screen eliminates infoglut because once enough observations are made to establish all 25 properties, then, as long as these values hold all additional data with the same values is redundant and not considered for decision making purposes: its not relevant. The IDO contains a binary array that tells which of the properties in the Ontology is present and which not by a 0/1 coding. This is used for probability filtering.

This is shown in FIG. 4. Evidence of the existence of an object and its lack of existence are both results of evidential reasoning. Evidence that exists but cannot be assigned to objects is unassigned. No hypothesis accounts for it. It can either be rejected as outlier data, or erroneous data or a new more expansive hypothesis can be generated that accounts for it.

The term of “abstraction” has been used in computer science in a number of sub-disciplines for some time. In this context it refers to the amount of detail that is provided for objects. A jeep categorized differently from other objects in that it is a vehicle that is (1) small, (2) motorized, (3) open, and is (4) all-wheel drive. The evidence may be insufficient to identify the jeep from a small convertible, but for purposes of supporting one or more the decision support hypotheses it may be sufficient to use only properties (1) and (2). In exact terms this means that a more abstract object, “small motorized vehicle” exists and a jeep is also an instance of it. The Ontology shows all such classes and allows queries to be made at any level of abstraction. If this is done, then more evidence may “come in from the cold” and be associated with the hypotheses with striking results, as shown in FIG. 4.

This is shown in FIG. 4. Evidence of the existence of an object and its lack of existence are both results of evidential reasoning. Evidence that exists but cannot be assigned to objects is unassigned. No hypothesis accounts for it. It can either be rejected as outlier data, or erroneous data or a new more expansive hypothesis can be generated that accounts for it.

The PRP also allows an alternative use of fuzzy logic. Whereas it is possible to assign a measure to a data that provides an ordinal scale mapping to values like “certainly, Probably, etc.” a novel technique of applying measures results in an exact abstraction with a name that incorporates the fuzziness. The evidence on hand is describes exactly, and the fuzziness is refected in the name of the object created—it is not as exact as one would wish to have, but it summarizes precisely what is known.

The term of “abstraction” has been used in computer science in a number of sub-disciplines for some time. In this context it refers to the amount of detail that is provided for objects. A jeep categorized differently from other objects in that it is a vehicle that is (1) small, (2) motorized, (3) open, and is (4) all-wheel drive. The evidence may be insufficient to identify the jeep from a small convertible, but for purposes of supporting one or more the decision support hypotheses it may be sufficient to use only properties (1) and (2). In exact terms this means that a more abstract object, “small motorized vehicle” exists and a jeep is also an instance of it. The Ontology shows all such classes and allows queries to be made at any level of abstraction. If this is done, then more evidence may “come in from the cold” and be associated with the hypotheses with striking results, as shown in FIG. 4.

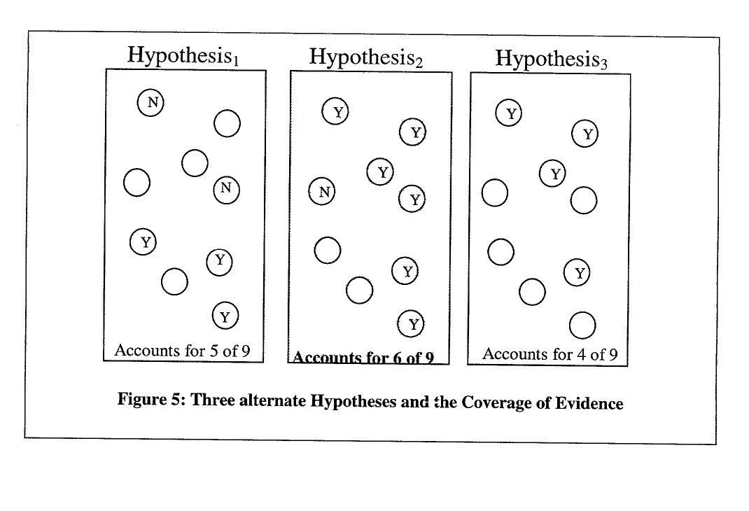

Sensor data coming into the system is directly mappable to a set of DIDs—data ID arrays. Each sensor has its own particular types of data that it gathers in its spectrum, and some sensors may output interpretations of what has been observed. This means that there are a number of different types of attributes that can be found. Let the input be a X-coordinate, a Y-coordinate and three values V₁ through V₃. These are then put in the “dimensional baskets”, as shown in FIG. 5.

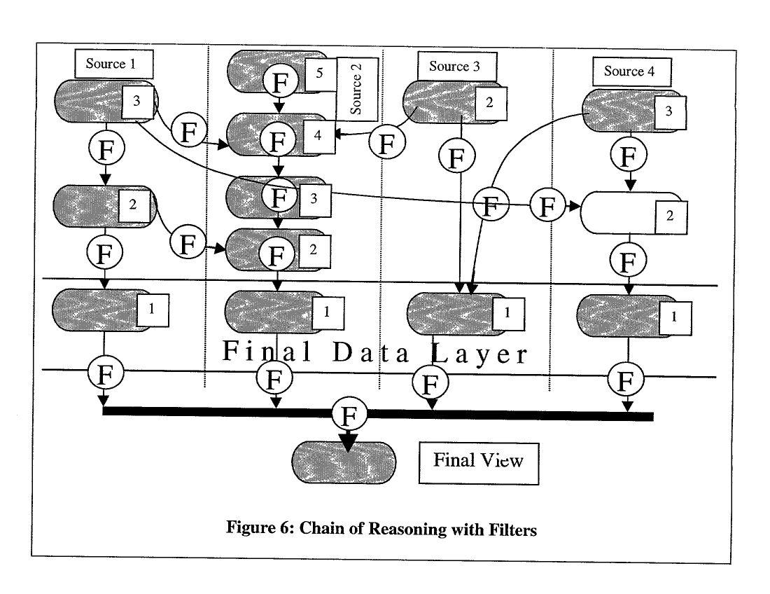

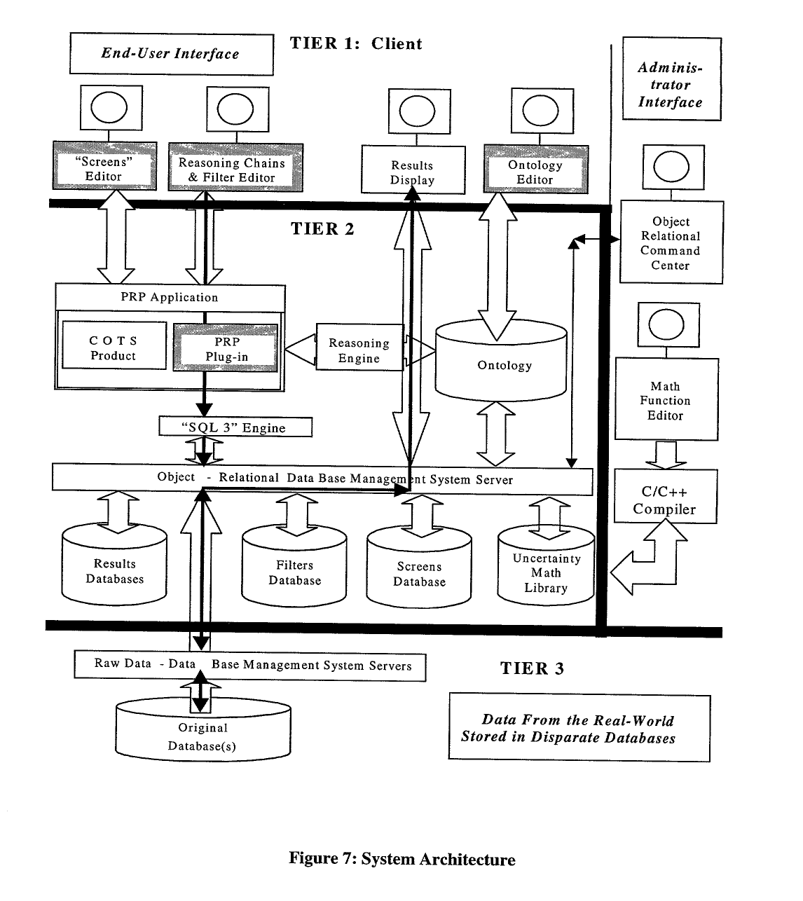

The input needs then to be connected with the type of decision that must be made. The objects that may be present are represented in the Ontology. The Ontology provides ranges that the variables V₁ though V₃ may have and be consistent with the presence of the particular object that is being defined. This is shown for Object 1 of three possible objects in FIG. 6. This will result in three different ranges for the variables V₁ to V₃ depending on what object they identify (e.g. truck, jeep, tank). This means that the table of grouped data can be pivoted. In FIG. 7 we see it graphically.

This becomes a table upon which a clustering process of association (e.g. data mining) can proceed: groups of data values for different objects in the same 2,3 or 4-dimensional area will be compared to see to what objects they correspond. The value of this approach is that it works hand in glove with the abstraction technique. The pivoted table provides a summary of all of the input data, transformed into evidence. It is then possible to dynamically adjust the level of abstraction to take advantage of what data exists. However, even when inadequate data is present this can be useful.

The level of abstraction of data available “small vehicle” may lack sufficient detail, i.e. is it motorized or not to be useful directly. However, the filtering mechanism may be invoked here as well. The filter would normally exclude a piece of evidence for a small vehicle for being considered a jeep or a car if it only had two out of four identifications. On the other hand, the user could have a hypothesis of a “worst case” scenario and assume that all of the “small vehicles” were jeeps just to see what threat would be possible in this case. This could be compared to the traditional approach where an object is not part of a threat until it is identified as one.

The system must allow the PRP user to change parameters for uncertainty via filters and for the objects to be fused via Ontology entries. Summarized, the requirements of such a system are that the user must be able to specify (1) a set of data sources, or a process such as a search engine query that supplies them. For each data source the user must specify (2) the processing filter to be used to include or omit the data. Each filter consists of transformations, including (3) the user supplied parameters for screening out any data with too high an uncertainty. The filter at the final data level should include (4) the last (higher) level of detail at which information is to be processed and (5) how frequently the data is to be updated. In addition the user must specify (5) the Final View's filter for combining the final sources of data. This section discusses the fusion of data using objects and the application of Evidential Reasoning, the use of an Ontology and screens. The PRP results are displayed to the user and changes like the above are made to explore the possible interpretations of the evidence.

The various embodiments and modifications of the present invention are not just those which have been heretofore described, but also all those within the scope of the following claim.

I claim:

1. A process for reasoning about the real world's representation as a database stored on a computer, comprising:
organizing computer representations of information together with the representation of the presumed relationships that exist among elements of said information;
applying and recording corresponding measures of completeness and correctness of said information; and
generating a new measure that provides a useful new description of said information that summarizes it concisely.
